(19) United States
(12) Patent Application Publication
(10) Pub. No.: US 2014/0165314 A1
(43) Pub. Date: Jun. 19, 2014

(54) Apparatus for dry cleaning layer pads

(71) Applicant: AUTOMATION CONCEPTS & SOLUTIONS PTY LTD, Victoria (AU)

(72) Inventor: Gary Tempany, Melbourne (AU)

(73) Assignee: Automation Concepts & Solutions Pty Ltd

(21) Appl. No.: 14/118,569

(22) PCT Filed: May 21, 2012
(86) PCT No.: PCT/AU2012/000572

§ 371 Date: Feb. 7, 2014

(30) Foreign Application Priority Data
May 19, 2011 (AU) 2011901954

(51) Int. Cl. B08B 1/02; B08B 1/00; B08B 13/00

(52) U.S. Cl. CPC B08B 1/02; B08B 13/00; B08B 1/002
USPC 15/77

(57) ABSTRACT

An improved dry cleaning system for cleaning used layer pads comprising a pallet in-feed assembly, a dry cleaning assembly, and an out-feed station, said dry cleaning assembly having a vision inspection system mounted to a conveyor for taking image/information of upper and lower surfaces of the cleaned layer pad exiting a cleaning station and a programmable means for assessing the image/info against predetermined acceptable cleaning criteria, wherein when these criteria are satisfied the programmable means actuates a guide means to direct the layer pad to a designated receptable for collection and re-use.

### FIELD OF THE INVENTION

The present invention relates to apparatus for dry cleaning of layer pads. In particular the present invention relates to an improved apparatus for efficient cleaning of a plurality of used layer pads in a dry system for re-use.

### BACKGROUND OF THE INVENTION

Layer pads are used in the pallet industry to allow stacking of food and drink receptacles such as bottles and jars, of both plastic and glass, on a pallet. The use of a layer pad between stacked layers of receptacles on a single pallet has allowed significant efficiency gains in receiving and transporting food and drink.

A conventional layer pad, which separates bottles and jars and the like receptacles, is generally constructed from composite material comprising a layer of cardboard and masonite, or plain fibreboard.

In a composite layer pad the cardboard layer is effective in conforming to the shape of a top portion of a bottle or the like receptacle and thereby stabilizing the layers of bottles on a pallet. The masonite layer provides a harder surface on which a bottom portion of a bottle or like receptacle is seated. The surface of the masonite has a low relative coefficient of friction to allow the seated bottles to more readily slide off and onto a layer pad.

Because layer pads are used closely in the food and drinks industry, they have to meet strict regulations concerning health and hygiene. Thus the cleanliness of layer pads becomes an issue. Once used, a layer pad may become dirty and contaminated, hence may be discarded as a health hazard. Continual replacement of a used layer pad represents a substantial expense and waste as in a single pallet, multiple layer pads are used and discarded to waste. Conversely a layer pad may become damaged with repeated use, and once damaged a layer pad often fails to fulfill its desired characteristics, which can in turn render a loaded pallet unsafe and dangerous.

There is thus a need to provide a means of extending the useful life of a conventional layer pad.

Traditionally, composite layer pads have been cleaned by hand with a manual inspection to ensure that they are of sufficient quality to be re-useable. This type of approach is limited by being able to detect a precise level of cleanliness, that is, a layer pad could pass a visual inspection and still harbor bacteria.

Machines are known to wash layer pads using jets of hot water. Such machines while representing an advance over manual cleaning and inspection have proven to be less than desirable for composite layer pads. For example, composite layer pads have a tendency to absorb water causing warping and general structural deficiency. There is thus a need to constantly monitor the quality of recycled layer pads.

In one attempt to address the drawback with composite layer pads, the present applicant has developed a dry washing system. The masonite layer of a conventional layer pad however is prone to burring at the edges causing extensive edge damage which could not be detected.

It was also found that the edges of the masonite layer of the pad tended to split and separate when subjected to rough handling such as fork lift damage. Such damage meant that pieces of masonite would often be dislodged from the layer pad by the action of scrubbers in a scrubbing chamber and this resulted in a need to shut down the system so that the scrubbing chamber could be cleaned.

Further, the masonite layer has a tendancy to warp if stacked poorly onto a pallet and/or it has been wet at some stage. In some instances badly warped pads were getting stuck in the scrubbing chamber resulting in an operator having to shut down the system to release the warped pad. It would be an advantage if a system could be provided which is substantial automatic.

Even further, the applicant's system relies on stacking of used layer pads on a pallet within the general perimeter of the pallet. In practice however the layer pads are prone to movement and/or slippage over one another during transport or being just poorly stacked by a user. Consequently rearrangement of a stack of used layer pads was required before the system could b used, which created a labor intensive step.

Other attempts to address the problems with cleaning conventional composite layer pads have seen the introduction of layer pads fabricated from plastic materials. While this by itself may help address the issue associated with wetting of conventional layer pads, it is unlikely that plastic layer pads will replace conventional composite layer pads. The applicant's own dry cleaning system is also problematic in terms of handling plastic layer pads because plastic layer pads are significantly thinner than comparable conventional composite layer pads. Even further, plastic layer pads create static electricity which is generally unsuitable for dry systems.

Hence there remains a need for a cleaning system which can cater for layer pads of the conventional type and plastic layer pads.

It is an object of the present invention to address one or more of the foregoing problems. It is a further object to provide the public with a useful alternative.

### SUMMARY OF THE INVENTION

The present invention is directed to an improved dry cleaning system for cleaning used layer pads of composite material and/or plastic material including:
a pallet in-feed sub-assembly for processing and transferring used layer pads from a pallet of used stacked layer pads;
a dry cleaning assembly downstream from the sub-assembly including:
   a conveyor means for receiving a layer pad from the layer pad transfer means and transferring the layer pad over a defined cleaning pathway, the conveyor means including guide rails to orient he layer pad for tracking throughout the pathway;
   a dry scrub cleaning station including scrubbing means located in the pathway of the conveyor means for substantially removing dirt and debris from surfaces of a layer pad as the layer pad passes over or through the scrubbing means, the dry scrub cleaning station including a dust/debris collection means located relative to the scrubbing means for collecting dirt and debris removed from the layer pad; and
   a vision inspection system mounted to the conveyor means for taking image(s) of upper and lower surfaces of the layer pad along a portion of the pathway downstream from the cleaning station, wherein the image(s) are input into a programmable means which assesses the images against predetermined acceptable levels of moisture and/or surface/edge damage;
an out-feed station downstream from the vision inspection system including a guide means operably connected to the programmable means, and one or more receptacles located aft of the conveyor means for receiving layer pads; and
wherein layer pads are transferred from the sub-assembly to the conveyor for traversing over the defined cleaning pathway whereby when a layer pad is assessed by the programmable means as having a moisture content and/or damage less than or equal to the predetermined acceptable levels the programmable means actuates the guide means to direct the layer pad to a designated receptacle for receiving acceptable clean layer pads for re-use.

The instant dry cleaning system represents an advance over prior art systems because the improved system is able to clean conventional and developing pad types of composite, plastic and fibreboard materials of various pad sizes and thickness. Further, the instant dry cleaning system is more efficient than prior art systems as there is less inadvertent and false rejects, less down time due to system failures such as clogging, and the improved system can handle damaged, bent, warped or broken layer pads.

The pallet in-feed sub-assembly can include:
(i) a delivery in-feed conveyor for receiving and transferring at least one pallet of stacked used layer pads; and
(ii) a pallet control means downstream from the delivery in-feed conveyor, the pallet control means adapted to position the pallet on the in-feed conveyor for transferring a used layer pad from the at least one pallet onto the dry cleaning assembly.

The pallet in-feed sub-assembly can further include at least one pusher device located above a stack of layer pads on a pallet for arranging the stacked layer pads within predetermined limits of the pallet.

The pallet in-feed sub-assembly can further include a gravity out-feed conveyor for receiving spent pallets after being processed. Preferably the gravity out-fed conveyor is not powered, and relies on pallets being in reasonable condition to operate successfully.

The pallet control means can include a lift hoist and power conveyor adapted for elevating the pallet being processed to a desired height for transfer of a layer pad to the dry cleaning assembly for processing.

The lift hoist can comprise a scissor lift wherein height is controlled by a sensor to maintain a desired height for ensuring layer pad alignment with pushers so that the pushers make correct contact with the pads. If the layer pads are warped the height can be varied to compensate for warping hence the system can receive warped and bent pads.

The pallet control means of the sub-assembly can include an ejection means to eject the pallet onto the gravity out-feed conveyor.

The improved dry cleaning system can further include a transfer means between the sub-assembly and dry cleaning assembly, wherein the transfer means is adapted to pick up and locate a top layer pad from the pallet on to the conveyor means.

The transfer means can include:
(i) a vacuum head assembly comprising a vacuum generator, suction cups and a frame;
(ii) a head frame guided cylinder for adjusting the height of the head assembly; and
(iii) a gantry linear drive for providing substantially horizontal movement to the head assembly between the pallet control means and the conveyor of the dry cleaning assembly.

The dry cleaning assembly can include a substantially sealed sanitizing chamber located on the pathway downstream from the dry scrub station, the sanitizing chamber having a closeable inlet and outlet ends for passage of the layer pad from the scrub station therethrough, wherein the sanitizing chamber includes a sanitizing means for substantially reducing contamination on the layer pad as the layer pad passes through the chamber.

The vision inspection system can include a moisture detection sensor(s) located adjacent the outlet of the sanitizing chamber for detecting the level of moisture in the layer pad, wherein the image(s) and information received by the moisture detection sensor(s) are assessed by programmable means against predetermined acceptable levels of moisture and surface/edge damage.

The dry cleaning system can further include a warped layer pad sensor located on the conveyor upstream from the dry scrub station. The warped pad sensor is operably connected to the conveyor and is programmed to detect pads having bends or warpage defects of a size or geometry greater than the dimensions of the scrub station wherein once detected the sensor actuates to reverse the direction of the conveyor.

The dry cleaning system can also include a preliminary layer pad reject receptacle adjacent the transfer means for receiving rejected layer pads detected by the warped layer pad sensor.

In a related aspect of the present invention there is disclosed an improved dry cleaning system for cleaning used layer pads of composite material and/or plastic material including:
a pallet in-feed sub-assembly for processing and transferring used layer pads from a pallet of used stacked layer pads, the sub-assembly including:
   a delivery in-feed conveyor for receiving and transferring at least one pallet of stacked used layer pads; and
   a pallet control means downstream from the delivery in-feed conveyor, the pallet control means adapted to position the pallet on the in-feed conveyor for transferring a used layer pad from the at least one pallet onto the dry cleaning assembly.
a dry cleaning assembly downstream from the sub-assembly including:
   a conveyor means for receiving a layer pad from the layer pad transfer means and transferring the layer pad over a defined pathway, the conveyor means including guide rails to orient he layer pad for tracking throughout the pathway;
   a dry scrub cleaning station including scrubbing means located in the pathway of the conveyor means for substantially removing dirt and debris from surfaces of a layer pad as the layer pad passes over or through the scrubbing means, the dry scrub cleaning station including a dust/debris collection means located relative to the scrubbing means for collecting dirt and debris removed from the layer pad;
   a substantially sealed sanitizing chamber located on the pathway downstream from the dry scrub station, the sanitizing chamber having a closeable inlet and outlet ends for passage of the layer pad from the scrub station therethrough, wherein the sanitizing chamber includes a sanitizing means for substantially reducing contamination on the layer pad as the layer pad passes through the chamber;
   a vision inspection system mounted to the conveyor means downstream from the sanitizing chamber, the vision inspection system including:
      at least a pair of camera devices being oppositely disposed above and below the conveyor means for taking images of upper and lower surfaces of the layer pad exiting the sanitizing chamber;
      a moisture detection sensor(s) located adjacent the outlet of the sanitizing chamber for detecting the level of moisture in the layer pad;
      wherein the image(s) and information received by the moisture detection sensor(s) are assessed by programmable means against predetermined acceptable levels of moisture and surface/edge damage;
a transfer means between the sub-assembly and the dry cleaning assembly, wherein the transfer means is adapted to pick up a top layer pad from the pallet and transfer to the conveyor means;
an out-feed station downstream from the vision inspection assembly including a guide means operably interconnected to the programmable means, and one or more receptacles located aft of the conveyor means for receiving layer pads; and
wherein when a layer pad is assessed by the programmable means as having a moisture content and/or damage less than or equal to the predetermined acceptable levels the programmable means actuates the guide means to direct the layer pad to a designated receptacle for receiving acceptable clean layer pads for re-use.

Preferably the moisture detector(s) comprise a camera system which scans the surfaces of a layer pad on a single pass and identifies layer pads of pre-determined moisture content as pass or reject.

The scrubbing means can include a pair of rotary brushes. The rotary brushes can rotate at about 240 rpm for providing a scrubbing action to both the top and bottom surface of a layer pad.

The dust/debris collection means can include a debris hopper connected to a dust extractor system. The dust collection means can also include a pair of high pressure fan slots for blowing dust from the pad after scrubbing action.

The sanitizing chamber is preferably subject to negative pressure differential causing air to be preferentially drawn into the chamber from outside the chamber for cooling the lamps and reducing dust.

The sanitizing chamber can include a series of spaced apart high pressure mercury vapour lamps for providing a source of ultra-violet light to surfaces of a layer pad as it passes through the sanitizing chamber. Preferably the exit of the sanitizing chamber includes two steel flaps hingedly connected thereto which opens and closes as a layer pad passes through to minimize leaking of ultra violet light about the pad. The sanitizing chamber is effectively sealed to minimize ultra violet light emissions outside of the chamber.

The dry cleaning assembly can further include an inspection and sorting conveyor means located aft of the sanitizing chamber for urging transfer of a layer pad from the sanitizing chamber through the vision inspection system for quality assessment of the layer pad. The inspection and sorting conveyor means can also include a recessed or a stepped portion(s) therein and one or more layer pad receiving receptacle(s) adjacent the recessed/stepped portion(s) for receiving a layer pad of designated quality.

The layer pad receiving receptacle(s) adjacent the recessed or stepped portion(s) of the inspection and sorting conveyor means receive layer pads assessed passed or rejected. The receptacles can include an angled slide adjacent the recessed portion to allow the pads to slide from the conveyor to a position for delivery into a receptacle. The receptacle(s) can be fitted with a sensor located at lower edge portions of the angled slide which controls rotation movement of the slide as a pad is received in the slide portion for dropping the pad into the receptacle(s).

Preferably the dry cleaning system is adapted to process layer pads including palletized dirty plastic/cardboard layer pads at a speed of 600 pads per hour.

### DESCRIPTION OF THE DRAWINGS

An embodiment of the present invention will now be described by way of example only with reference to the accompanying drawings in which:

FIG. 1: is a schematic cross-sectional side view of an improved dry cleaning system for leaning composite masonite/cardboard and plastic layer pads;

FIG. 2: is a plan view of the improved dry cleaning system of FIG. 1;

FIG. 3: shows a photograph of a pallet receiving element in accordance with one embodiment of the present invention.

FIG. 4: shows a photograph of a transfer means in accordance with one embodiment of the present invention.

FIG. 5: shows a photograph of a front portion of a conveyor element in accordance with one embodiment of the present invention.

FIG. 6: shows a photograph of a scrub station in accordance with one embodiment of the present invention.

FIG. 7: shows a photograph of a sanitizing chamber in accordance with one embodiment of the present invention.

FIGS. 8 & 8A: show a photograph of a vision inspection system in accordance with one embodiment of the present invention.

FIG. 9: shows a schematic representation of vision system methodology in accordance with one embodiment of the present invention.

FIG. 10: shows a photograph of a series of receiving receptacles in accordance with one embodiment of the present invention.

FIG. 11: shows a photograph of a pallet with stacked used layer pads in accordance with one embodiment of the present invention.

### DESCRIPTION OF THE PREFERRED EMBODIMENT WITH REFERENCE TO THE DRAWINGS

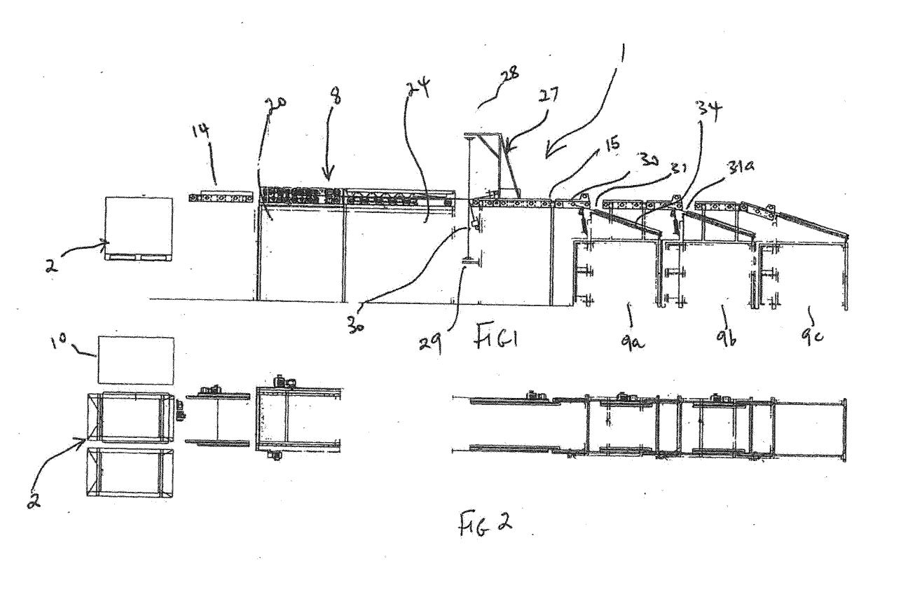

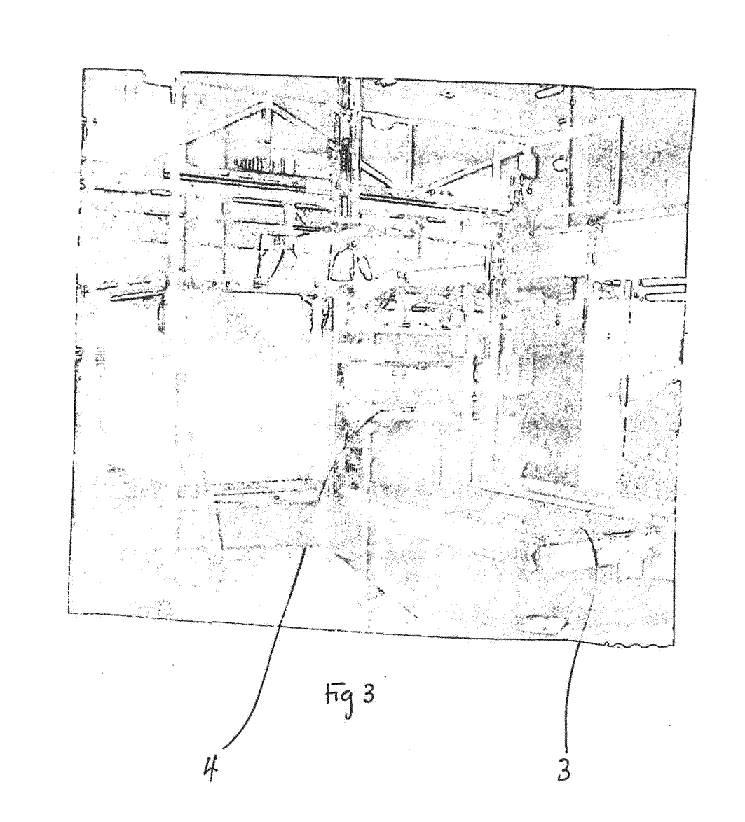

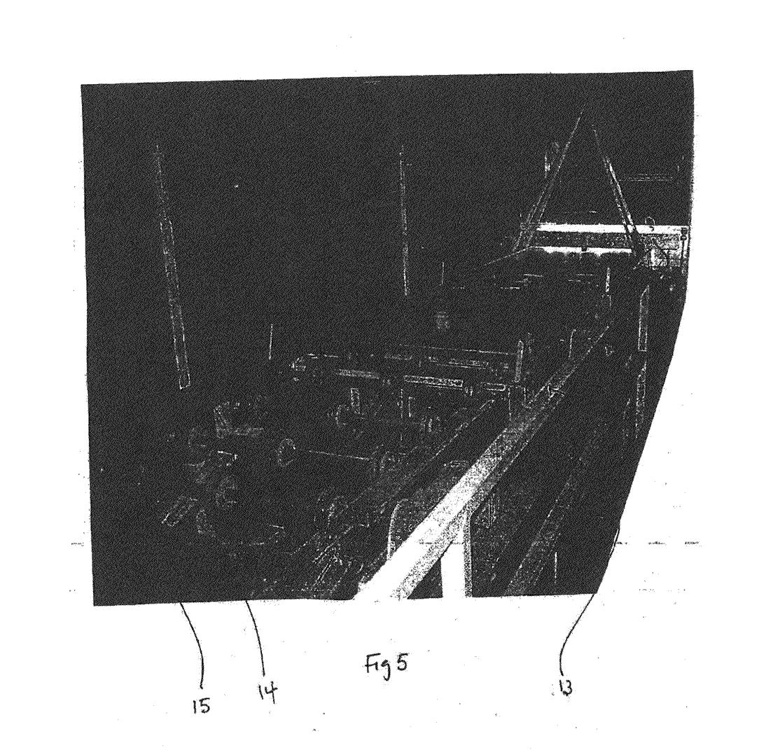

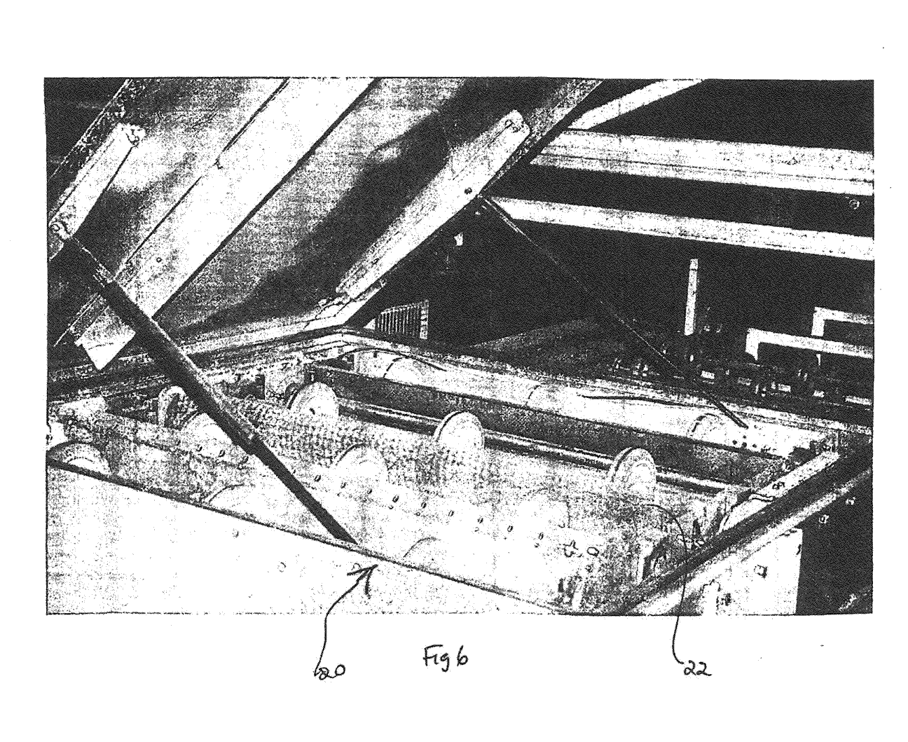

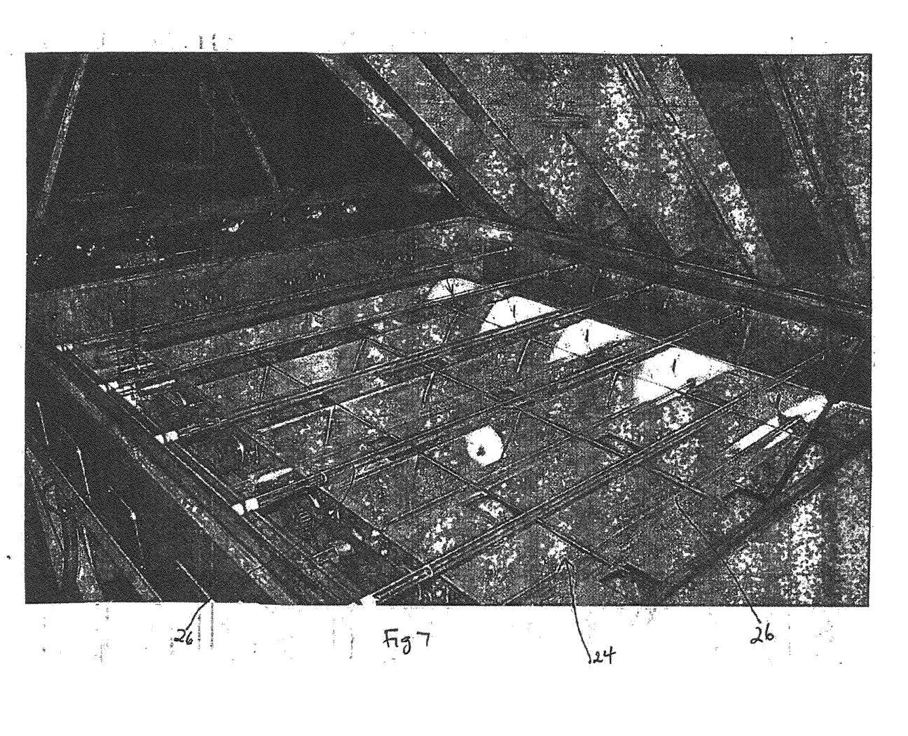

Referring to FIGS. 1 and 2 there is shown an improved dry cleaning system 1 for cleaning layer pads of both composite masonite/cardboard type and plastic type. The system 1 includes a pallet in-feed sub assembly 2, a transfer station 7 (FIG. 4), a dry cleaning assembly 8 comprising a cleaning conveyor 11 defining a cleaning pathway through a plurality of cleaning zones, and layer pad receptacles 9a, 9b and 9c for receiving clean and rejected layer pads.

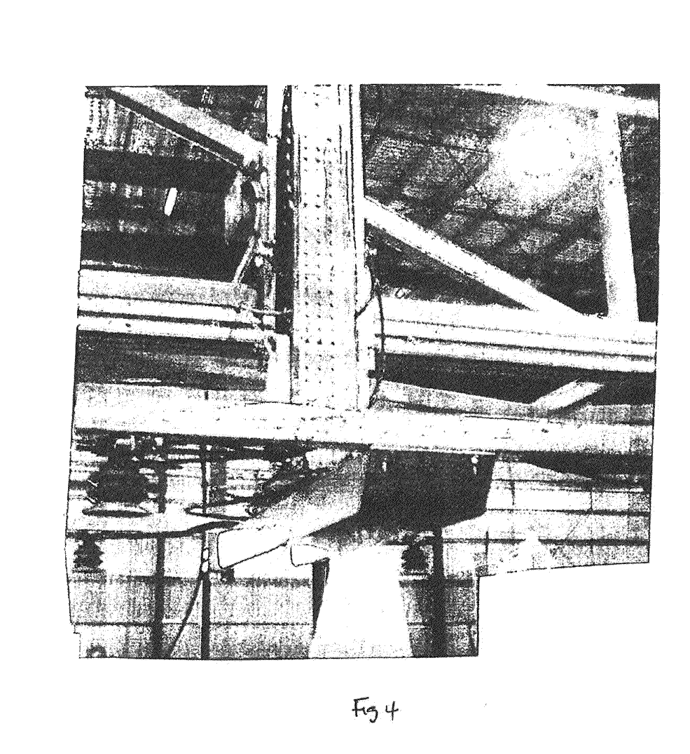

The pallet in-feed sub assembly comprises a delivery in-feed conveyor 3 (best seen in FIG. 3), and a pallet control device 4. In operation a pallet of stacked used layer pads 5 (best seen in FIG. 11) is received on the delivery in-feed conveyor 3 which transfers the pallet to the pallet control means.

Used layer pads often arrive interspersed between plastic layer pads and top frames. Since top frames are much thicker and the plastic layer pads are of a different colour, a thickness sensor and a colour sensor are used to distinguish the composite layer pads from the plastic layer pads and top frames. A suction device picks up the composite layer pads and places them onto a conveyor. The other pads are ejected to a collection zone.

The pallet control means includes a layer pad pusher (not shown) and hoist in the form of a scissor lift 6. The pusher functions to assist orienting the layer pads on the pallet so that the dimension of the pads and pallet is substantially maintained within the confines of the in-feed conveyor. The scissor lift 6 adjusts the height of the pallet to present the pads at an effective position for pick-up by a transfer means 7 (see FIG. 4) downstream therefrom. The scissor lift includes an eject function which urges an empty pallet onto a gravity out-feed conveyor (not shown). Once all used layer pads have been removed from a pallet, the empty pallet is urged by the gravity out-feed conveyor to a pallet receptacle 10. When the in-feed pallet is empty it is then automatically transferred to the gravity discharge conveyor and the next full pallet will be positioned onto the scissor lift.

As seen in FIG. 4, the system includes a transfer means 12 located between the sub-assembly and dry cleaning assembly 8. The transfer means includes a vacuum head assembly comprising a vacuum generator, suction cups and a frame; a head frame guided cylinder for adjusting the height of the head assembly; and a gantry linear drive for providing substantially horizontal movement to the head assembly between the pallet control means and the conveyor of the dry cleaning assembly.

In operation, the transfer means is adapted to pick up a top layer pad from the stacked pallet and transfer the layer pad on to the dry cleaning assembly 8. The pallet of layer pads to be leaned is placed onto an in-feed chain conveyor which will position it automatically onto a scissor type lift in the caged areas at the in-feed end of the system. A transfer means using vacuum grippers will then pick up the front edge of the uppermost layer pad and feed them between 2 driven gripper rollers that will drive the pad into the system.

The dry cleaning assembly includes a conveyor 13 having guide rails 14 for maintaining alignment of the layer pads throughout the dry cleaning assembly. The conveyor includes a series of spaced drive wheels 15 which engage at least the underside of the layer pads so that rotation of the drive wheels propels the pads along the length of the dry cleaning assembly.

In one embodiment the conveyor comprises a series of spaced chain driven shafts each of which support three-spaced polyurethane wheels 15 that engage the surface of the layer pad. The layer pad is usually 1420 mm×1090 mm×8 mm though it is understood that the machine can be configured to suit any size and thickness of layer pad. The guide rails are positioned on either side of the conveyor to accommodate the width of the layer pads to ensure they are aligned during their passage along the conveyor. The chains are driven by suitably positioned electric motors with integral speed reduction gearboxes.

The conveyor 13 defines a cleaning pathway between a forward portion 15 and an aft portion 16. A used layer pad commences its passage over the cleaning pathway at the forward portion of the conveyor. The forward portion of the conveyor feeds used layer pads into a first cleaning station downstream.

The forward portion of conveyor 13 includes a layer pad receptacle (not shown) located adjacent thereto, and a first sensor operably connected to the conveyor for detecting bent or warped layer pads. In operation, a used layer pad which is sized, as a result of warpage or other damage, larger than the first cleaning station, the sensor actuates the conveyor to reverse its direction. In this case a warped layer pad, which would otherwise cause damage and stoppage of the processing, is moved towards the layer pad receptacle and removed from the system to minimize damage to various cleaning stations.

Within the cleaning pathway there is a series of cleaning and inspections stations/chambers. The first cleaning station is a dry scrub station 20. The dry scrub station receives layer pads from the forward potion of the conveyor. The dry scrub station is fitted with a pair of rotary brushes 22 that rotate at about 240 RPM providing a scrubbing action to the both the top and bottom of the layer pad as the layer pad passes through the station. The dry scrub station also includes a debris hopper (not shown) at one end which is connected to a dust extractor system (not shown). There is also a pair of high pressure fan slots (not shown) that blow the dust of the board after the scrubbing operation.

Whilst being driven, a layer pad passes through the pair of rotating scrub brushes. At the end of the chamber the pad then passes through a vacuum/blow off slot which is supplied with high velocity, low pressure filtered air. The system incorporates antistatic generators in the system to assist in the release of dust particles. The scrubbing chamber is evacuated via a duct on its side to a filtered dust extraction unit. This vacuum unit also provides a slight negative pressure to the entire machine so as to eliminate dust emissions to the machines vicinity.

In one embodiment the conveyor 13 is positioned above and below each layer pad so the polyurethane wheels 15 engage both the top and bottom surfaces of the layer pad to drive the pad past a pair of elongated, vertically spaced brushes, the pad being driven through the nip between the brushes. The brushes are driven by a common electric motor (chain driven) to rotate in counter-rotating directions.

The cleaning zone is housed in a chamber that has a pivoted lid to confine the air within the chamber. An air blast is directed to both the top and the bottom of each pad after it passes the brushes. The air is directed via a continuous slot diffuser and blows the foreign matter removed from the pads by the brushes through a vacuum system.

Once cleaned, the layer pads are then sent to a sanitizing chamber 24. The sanitizing chamber provides a closeable inlet and an outlet (not shown) between which there is located a series of high pressure mercury vapour lamps 26 that provide sanitizing ultra violet light to both surfaces of the layer pads as the pads are propelled thereover. The lamps are housed in V-shaped aluminium reflectors positioned at spaced intervals above and below the layer pad. The chamber is closed by a lid which pivots open to provide access to the chamber.

The chamber is substantially sealed to minimize UV light emissions outside the chamber. At the outlet slot of the chamber there is provided two, steel flaps (not shown) that open and close as a layer pad passes through. These serve to reduce UV light leaking around the board. A UV light protective shield is provided about the periphery of the chamber to minimize visible light from the outside of the chamber. The chamber overall has a negative pressure, causing it to draw air from the outside environment and through the UV chamber, providing cooling for the lamps and keeping dust at bay. This chamber is also fitted with a cooling fan to remove the heat produced by the lamps.

As shown in FIGS. 1, 2, 8 and 8A, the dry cleaning system includes a vision inspection system 27 mounted on a frame portion of the dry cleaning assembly downstream from the sanitizing chamber. The vision inspection system comprises an upper camera 28, a lower camera 29, and a bank of low angle halogen lamps 30. Images of upper and lower surfaces of the layer pad exiting the sanitizing chamber are taken by the cameras and information received is assessed by programmable means against predetermined acceptable levels of moisture and surface/edge damage;

The system also includes an out-feed station downstream from the vision inspection assembly including a guide means operably interconnected to the programmable means, and one or more receptacles 9 located aft of the conveyor means for receiving layer pads.

In operation a layer pad is assessed by the programmable means. If the moisture content and/or damage is determined as less than or equal to the predetermined acceptable levels the programmable means actuates the guide means to direct the layer pad to a designated receptacle for receiving acceptable clean layer pads for re-use.

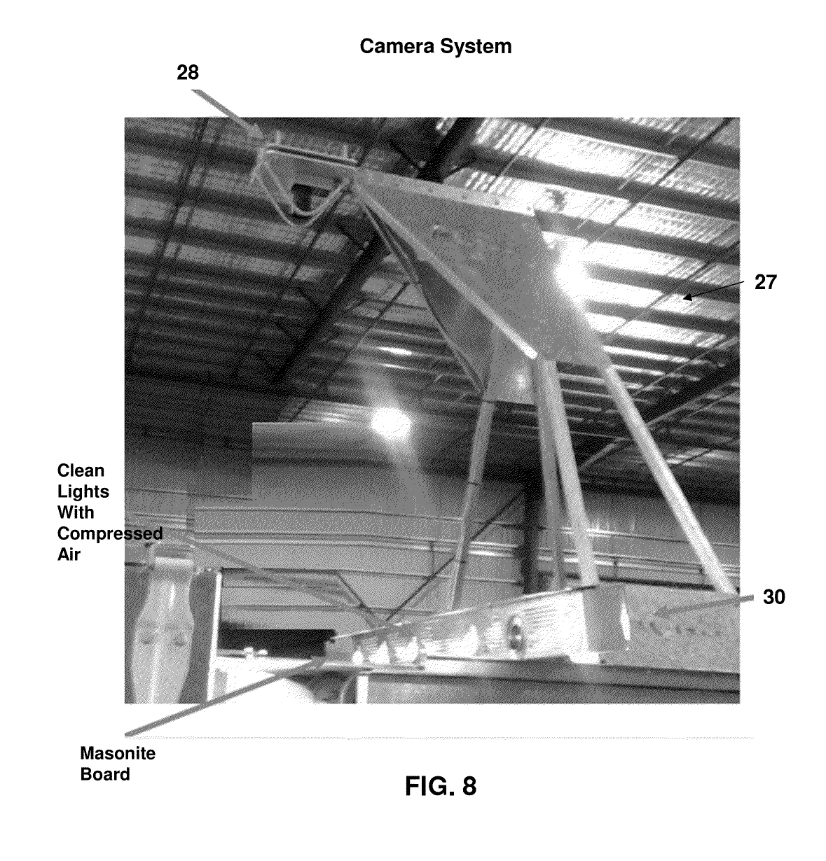

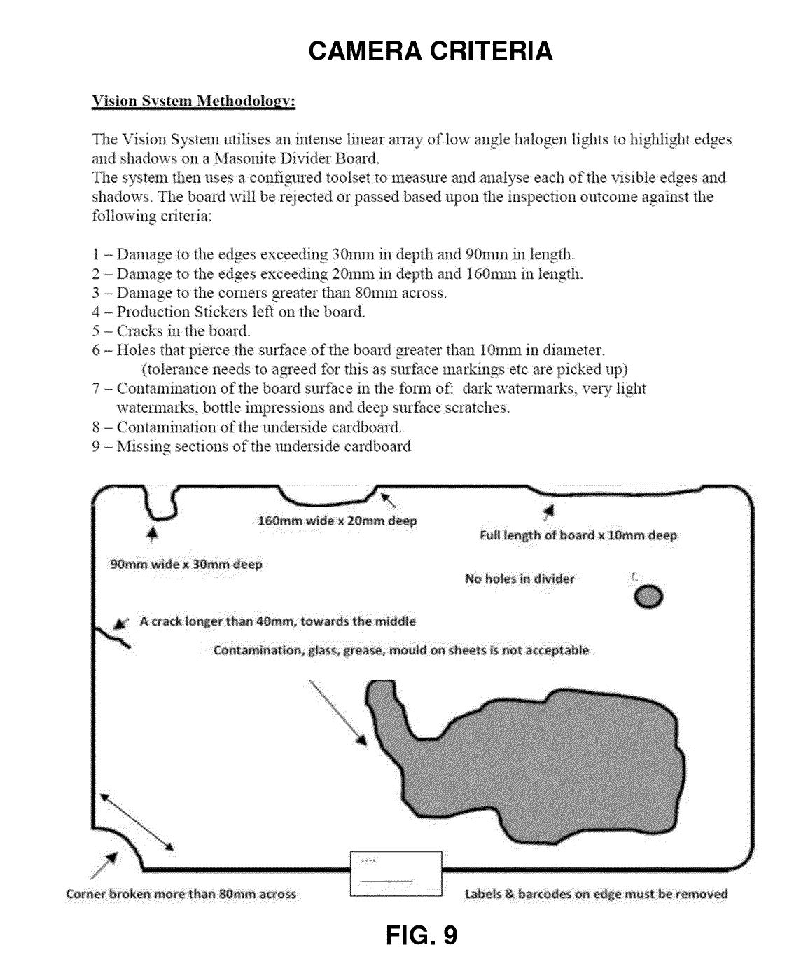

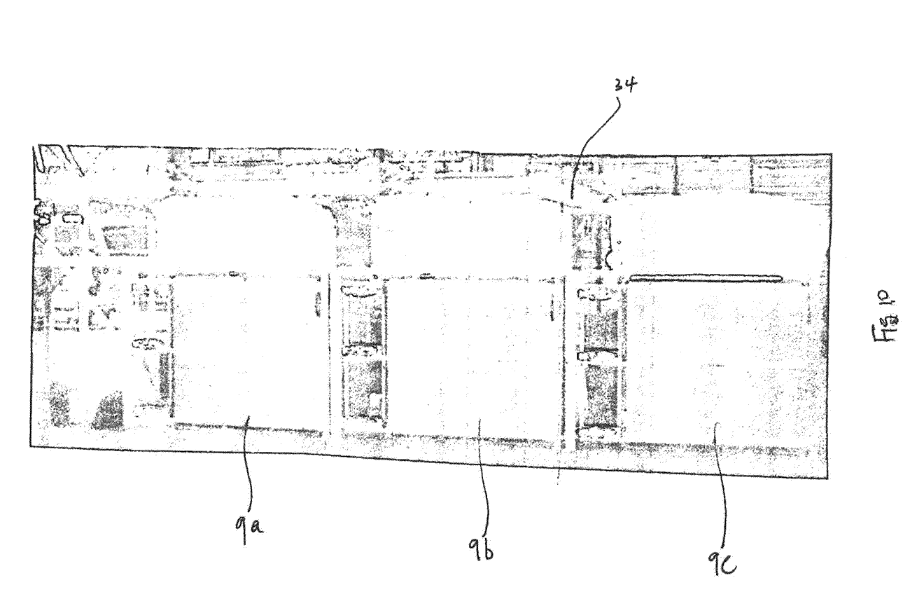

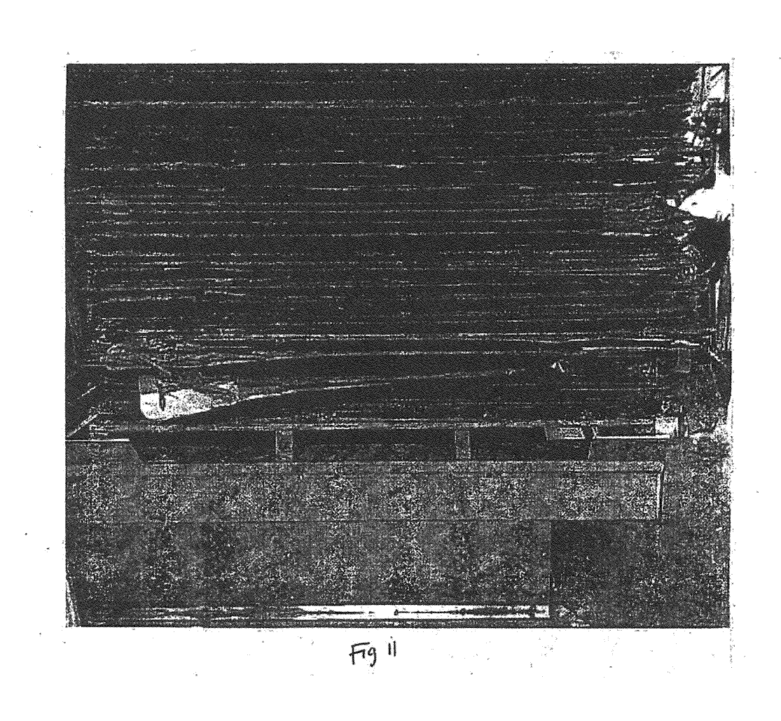

Referring to FIG. 8, the camera 28 faces downwards, therefore its lens will not require regular cleaning as dust is unlikely to settle on it. The low angle halogen lights need to be cleaned daily, as the dust in the factory settles on the globes overnight. The lights run at a high operating temperature and should be cleaned with compressed air before they are switched on. This is to ensure that none of the globes crack due to moisture in the compressor. An air nozzle located near Camera (not shown).

Turning to FIG. 8A, camera 29 faces upwards, allowing any dust or dirt in the air, to settle on the lens surface. This can cause image blurring and/or false defects. This lens should be kept clean at all times. There is also a lens cap that should be placed over the lens when the machine is not in use. This will stop any excess build up of grime on the lens surface.

The direct halogen lights need to be cleaned daily, as the dust in the factory settles on the globes overnight. The lights run at a high operating temperature and they should be cleaned with compressed air before they are switched on. This is to ensure that none of the globes crack due to moisture in the compressor. An air nozzle located near Camera 29 (not shown).

At the exit of the UV chamber there are 2 moisture detectors (not shown) that work through the camera system. These sensors are adjustable to a predetermined acceptable moisture level by rotating the knob next to the indicator lamp. This must be carried out by the operator periodically or when the level of moisture in the passed pads is unacceptable. Use a sample piece that is either just over or under the acceptable limit of moisture. Place it in front of the sensor in the same position as it will be normally passing. The yellow LED comes on when there is a significant reading but less than the amount needed to trip the relay. The red LED comes on when the relay trips and remains on until the contacts open again. During this time the red LED goes out. Now, turn the control knob until the relay just trips. If the sample has excessive moisture, this is the correct setting. For a sample that is just under the limit, back off the adjustment slowly to a position where the relay just turns off again, and increase it again and stop at the position just before it will trip. This is the correct setting, and you can mark the box at the pointer of the knob with an ink marker for future reference if you wish. After running, initially results need to be confirmed and the setting and make a fine adjustment if necessary.

The inspection and sorting conveyor means includes a recessed or a stepped portion(s) 31, 31a, therein and one or more layer pad receiving receptacle(s) 9 adjacent the recessed/stepped portion(s) for receiving a layer pad of designated quality.

The layer pad receiving receptacle(s) adjacent the recessed or stepped portion(s) of the inspection and sorting conveyor means receive layer pads assessed passed or rejected. The receptacles include an angled slide 34 adjacent the recessed portion to allow the pads to slide from the conveyor to a position for delivery into a receptacle. The receptacle(s) are fitted with a sensor (not shown) located at lower edge portions of the angled slide which controls rotation movement of the slide as a pad is received in the slide portion for dropping the pad into the receptacle(s).

Preferably the dry cleaning system is adapted to process layer pads including palletized dirty plastic/cardboard layer pads at a speed of 600 pads per hour.

Rejected pads are conveyed to the 3^{rd} drop box and counted. A maximum quantity of units is set within the systems control system. The cleaned accepted pads are counted, conveyed, tilted and gently dropped into the first drop box onto an awaiting pallet until the maximum quantity is reached, at which the system alerts the operator to remove the full pallet. The system will then use the second drop box in place of the first. If both boxes have the preset maximum of units the system is stopped and alarmed until either of the drop boxes are emptied by the operator. The placement of the pads on the pallet is accurate to the tolerances listed below.

1. An improved dry cleaning system for cleaning used layer pads of composite material and/or plastic material including:
a pallet in-feed sub-assembly for processing and transferring used layer pads from a pallet of used stacked layer pads;
a dry cleaning assembly downstream from the sub-assembly including:
a conveyor means for receiving a layer pad from the layer pad transfer means and transferring the layer pad over a defined cleaning pathway, the conveyor means including guide rails to orient he layer pad for tracking throughout the pathway; a dry scrub cleaning station including scrubbing means located in the pathway of the conveyor means for substantially removing dirt and debris from surfaces of a layer pad as the layer pad passes over or through the scrubbing means, the dry scrub cleaning station including a dust/debris collection means located relative to the scrubbing means for collecting dirt and debris removed from the layer pad; and
a vision inspection system mounted to the conveyor means for taking image(s) of upper and lower surfaces of the layer pad along a portion of the pathway downstream from the cleaning station, wherein the image(s) are input into a programmable means which assesses the images against predetermined acceptable levels of moisture and/or surface/edge damage;
an out-feed station downstream from the vision inspection system including a guide means operably connected to the programmable means, and one or more receptacles located aft of the conveyor means for receiving layer pads; and
wherein layer pads are transferred from the sub-assembly to the conveyor for traversing over the defined cleaning pathway whereby when a layer pad is assessed by the programmable means as having a moisture content and/or damage less than or equal to the predetermined acceptable levels the programmable means actuates the guide means to direct the layer pad to a designated receptacle for receiving acceptable clean layer pads for re-use.

2. An improved dry cleaning system for cleaning used layer pads of composite material and/or plastic<′> material according to claim 1 wherein the pallet in-feed sub-assembly includes:
a delivery in-feed conveyor for receiving and transferring at least one pallet of stacked used layer pads; and
a pallet control means downstream from the delivery in-feed conveyor, the pallet control means adapted to position the pallet on the in-feed conveyor for transferring a used layer pad from the at least one pallet onto the dry cleaning assembly.

3. An improved dry cleaning system for cleaning used layer pads of composite material and/or plastic material according to claim 1 wherein the pallet in-feed sub-assembly includes at least one pusher device located above a stack of layer pads on a pallet for arranging the stacked layer pads within predetermined limits of the pallet.

4. An improved dry cleaning system for cleaning used layer pads of composite material and/or plastic material according to claim 3 wherein the pallet in-feed sub-assembly further includes a gravity out-feed conveyor for receiving spent pallets after being processed, Preferably the gravity out-fed conveyor is not powered, and relies on pallets being in reasonable condition to operate successfully.

5. An improved dry cleaning system for cleaning used layer pads of composite material and/or plastic material according to claim 2 wherein the pallet control means includes a lift hoist and power conveyor adapted for elevating the pallet being processed to a desired height for transfer of a layer pad to the dry cleaning assembly for processing.

6. An improved dry cleaning system for cleaning used layer pads of composite material and/or plastic material according to claim 5 wherein the lift hoist includes a scissor lift wherein height is controlled by a sensor to maintain a desired height for ensuring layer pad alignment with pushers so that the pushers make correct contact with the pads. If the layer pads are warped the height can be varied to compensate for warping hence the system can receive warped and bent pads.

7. An improved dry cleaning system for cleaning used layer pads of composite material and/or plastic material according to claim 2 wherein the pallet control means of the subassembly includes an ejection means to eject the pallet onto the gravity out-feed conveyor.

8. An improved dry cleaning system for cleaning used layer pads of composite material and/or plastic material according to claim 1 wherein the improved dry cleaning system further includes a transfer means between the sub-assembly and dry cleaning assembly, wherein the transfer means is adapted to pick up and locate a top layer pad from the pallet on to the conveyor means.

9. An improved dry cleaning system for cleaning used layer pads of composite material and/or plastic material according to claim 8 wherein the transfer means includes: a vacuum head assembly comprising a vacuum generator, suction cups and a frame; a head frame guided cylinder for adjusting the height of the head assembly; and a gantry linear drive for providing substantially horizontal movement to the head assembly between the pallet control means and the conveyor of the dry cleaning assembly.

10. An improved dry cleaning system for cleaning used layer pads of composite material and/or plastic material according to claim 1 wherein the dry cleaning assembly includes a substantially sealed sanitizing chamber located on the pathway downstream from the dry scrub station, the sanitizing chamber having a closeable inlet and outlet ends for passage of the layer pad from the scrub station therethrough, wherein the sanitizing chamber includes a sanitizing means for substantially reducing contamination on the layer pad as the layer pad passes through the chamber.

11. An improved dry cleaning system for cleaning used layer pads of composite material and/or plastic material according to claim 1 wherein the vision inspection system includes a moisture detection sensor(s) located adjacent the outlet of the sanitizing chamber for detecting the level of moisture in the layer pad, wherein the image(s) and information received by the moisture detection sensor(s) are assessed by programmable means against predetermined acceptable levels of moisture and surface/edge damage.

12. An improved dry cleaning system for cleaning used layer pads of composite material and/or plastic material according to claim 1 wherein the dry cleaning system further includes a warped layer pad sensor located on the conveyor upstream from the dry scrub station, wherein the warped pad sensor is operably connected to the conveyor and is programmed to detect pads having bends or warpage defects of a size or geometry greater than the dimensions of the scrub station wherein once detected the sensor actuates to reverse the direction of the conveyor.

13. An improved dry cleaning system for cleaning used layer pads of composite material and/or plastic material according to claim 1 wherein the dry cleaning system also includes a preliminary layer pad reject receptacle adjacent the transfer means for receiving rejected layer pads detected by the warped layer pad sensor.

14. An improved dry cleaning system for cleaning used layer pads of composite material and/or plastic material including:
a pallet in-feed sub-assembly for processing and transferring used layer pads from a pallet of used stacked layer pads, the sub-assembly including:
a delivery in-feed conveyor for receiving and transferring at least one pallet of stacked used layer pads; and
a pallet control means downstream from the delivery in-feed conveyor, the pallet control means adapted to position the pallet on the in-feed conveyor for transferring a used layer pad from the at least one pallet onto the dry cleaning assembly;
a dry cleaning assembly downstream from the sub-assembly including:
a conveyor means for receiving a layer pad from the layer pad transfer means and transferring the layer pad over a defined pathway, the conveyor means including guide rails to orient he layer pad for tracking throughout the pathway;
a dry scrub cleaning station including scrubbing means located in the pathway of the conveyor means for substantially removing dirt and debris from surfaces of a layer pad as the layer pad passes over or through the scrubbing means, the dry scrub cleaning station including a dust/debris collection means located relative to the scrubbing means for collecting dirt and debris removed from the layer pad;
a substantially sealed sanitizing chamber located on the pathway downstream from the dry scrub station, the sanitizing chamber having a closeable inlet and outlet ends for passage of the layer pad from the scrub station therethrough, wherein the sanitizing chamber includes a sanitizing means for substantially reducing contamination on the layer pad as the layer pad passes through the chamber;
a vision inspection system mounted to the conveyor means downstream from the sanitizing chamber, the vision inspection system including:
at least a pair of camera devices being oppositely disposed above and below the conveyor means for taking images of upper and lower surfaces of the layer pad exiting the sanitizing chamber;
a moisture detection sensor(s) located adjacent the outlet of the sanitizing chamber for detecting the level of moisture in the layer pad;
wherein the image(s) and information received by the moisture detection sensor(s) are assessed by programmable means against predetermined acceptable levels of moisture and surface/edge damage;
a transfer means between the sub-assembly and the dry cleaning assembly, wherein the transfer means is adapted to pick up a top layer pad from the pallet and transfer to the conveyor means;
an out-feed station downstream from the vision inspection assembly including a guide means operably interconnected to the programmable means, and one or more layer pad receiving receptacles located aft of the conveyor means for receiving layer pads; and wherein when a layer pad is assessed by the programmable means as having a moisture content and/or damage less than or equal to the predetermined acceptable levels the programmable means actuates the guide means to direct the layer pad to a designated receptacle for receiving acceptable clean layer pads for re-use.

15. An improved dry cleaning system for cleaning used layer pads of composite material and/or plastic material according to claim 14 wherein the moisture detector(s) includes a camera system which scans the surfaces of a layer pad on a single pass and identifies layer pads of pre-determined moisture content as pass or reject.

16. An improved dry cleaning system for cleaning used layer pads of composite material and/or plastic material according to claim 14 wherein the scrubbing means includes a pair of rotary brushes, whereby the rotary brushes are adapted to rotate at about 240 rpm for providing a scrubbing action to both the top and bottom surface of a layer pad.

17. An improved dry cleaning system for cleaning used layer pads of composite material and/or plastic material according to claim 14 wherein the dust/debris collection means includes a debris hopper connected to a dust extractor system, whereby the dust collection means includes a pair of high pressure fan slots for blowing dust from the pad after scrubbing action.

18. An improved dry cleaning system for cleaning used layer pads of composite material and/or plastic material according to claim 1 wherein the sanitizing chamber is subject to negative pressure differential causing air to be preferentially drawn into the chamber from outside the chamber for cooling the lamps and reducing dust.

19. An improved dry cleaning system for cleaning used layer pads of composite material and/or plastic material according to claim 14 wherein the sanitizing chamber includes a series of spaced apart high pressure mercury vapour lamps for providing a source of ultraviolet light to surfaces of a layer pad as it passes through the sanitizing chamber.

20. An improved dry cleaning system for cleaning used layer pads of composite material and/or plastic material according to claim 19 wherein the exit of the sanitizing chamber includes two steel flaps hingedly connected thereto which opens and closes as a layer pad passes through to minimize leaking of ultra violet light about the pad, wherein the sanitizing chamber is effectively sealed to minimize ultra violet light emissions outside of the chamber.

21. An improved dry cleaning system for cleaning used layer pads of composite material and/or plastic material according to claim 14 wherein the dry cleaning assembly further includes an inspection and sorting conveyor means located aft of the sanitizing chamber for urging transfer of a layer pad from the sanitizing chamber through the vision inspection system for quality assessment of the layer pad.

22. An improved dry cleaning system for cleaning used layer pads of composite material and/or plastic material according to claim 21 wherein the inspection and sorting conveyor means includes a recessed or a stepped portion(s) therein and one or more layer pad receiving receptacle(s) adjacent the recessed/stepped portion(s) for receiving a layer pad of designated quality.

23. An improved dry cleaning system for cleaning used layer pads of composite material and/or plastic material according to claim 14 wherein the layer pad receiving receptacle(s) adjacent the recessed or stepped portion(s) of the inspection and sorting conveyor means receive layer pads assessed passed or rejected.

24. An improved dry cleaning system for cleaning used layer pads of composite material and/or plastic material according to claim 23 wherein the receptacles include an angled slide adjacent the recessed portion to allow the pads to slide from the conveyor to a position for delivery into a receptacle.

25. An improved dry cleaning system for cleaning used layer pads of composite material and/or plastic material according to claim 24 wherein the receptacle(s) are fitted with a sensor located at lower edge portions of the angled slide which controls rotation movement of the slide as a pad is received in the slide portion for dropping the pad into the receptacle(s).

26. An improved dry cleaning system for cleaning used layer pads of composite material and/or plastic material according to claim 14 wherein the dry cleaning system is adapted to process layer pads including palletized dirty plastic/cardboard layer pads at a speed of 600 pads per hour.

27 (canceled)
